(19) United States
(12) Patent Application Publication
(10) Pub. No.: US 2015/0200871 A1
(43) Pub. Date: Jul. 16, 2015

(54) Method of Accessing Information and Related Networks

(71) Applicant: Tribal Hives Limited, Kenilworth (GB)

(72) Inventors: Alex Cheung, Kenilworth (GB); Frank Cheung, Kenilworth (GB); Aaron Cambridge, Birmingham (GB)

(21) Appl. No.: 14/586,404

(22) Filed: Dec. 30, 2014

(30) Foreign Application Priority Data
Dec. 30, 2013 (GB) 1323104.8

(51) Int. Cl. H04L 12/911; G06F 17/30; H04L 29/08

(52) U.S. Cl. CPC H04L 47/782; H04L 67/10; G06F 17/3087

(57) ABSTRACT

A computerised method of allowing one or more users to access information is disclosed. The method includes causing a first computing device to transmit data representing a map to a remote computing device for display to a user thereof and receiving at the first computing device area-data defining a user defined area, relative to the map, wherein the area has associated therewith one or more user-defined parameters that hold for that area. The method further includes causing the first computing device to process the area-data and to link areas having the same, or at least similar, user-defined parameter associated therewith thereby building up a network of areas having the same, or at least similar, parameters and allowing the or each user to access the network of areas, by obtaining data from the first computing device, to obtain information about any one or more of the areas and/or of the network.

### TECHNICAL FIELD OF THE INVENTION

This invention relates to a method of accessing information and related networks. In particular, but not exclusively, this invention relates to the semantic web and facilitation of information retrieval.

### BACKGROUND

With the advent of the Internet and latterly the World Wide Web (WWW) information has become evermore prevalent. The advent of user generated content, such as blogs, Wiki-pedia, and other Web 2.0 technologies there is even more information available for users to view and sift through.

Typically WWW based maps are widely used to visualise geopspatial data but such maps are difficult to find, cannot be re-used and have no external meaning outside of that map.

Current Geographic Information Systems (GIS) are databases of geographical locations used by academics and government bodies typically used for research and forecasting. They have not been very successful in the mainstream/mass market as most GIS locations are not interesting from a social perspective.

The semantic web, in which meta-data is used to label data, has been proposed and has been mooted to be Web 3.0 but as yet little is made of such semantic labels. However, even if the use of such semantic labels were to become widespread the ease with which data can be retrieved might not be as user friendly, convenient, etc. as is desired.

Thus, despite the various search technologies that exist, it can be a technical problem to present information in a manner to allow that information to be retrieved easily; the location of information within the vast volumes of data that exists is a problem.

### SUMMARY OF THE INVENTION

According to a first aspect of the invention there is provided a computerised method of allowing one or more users to access information, the method including at least one of the following steps:
i) allowing any user to define an area, relative to a map wherein the area may have associated therewith one or more user-defined parameters that hold for that area;
ii) the method allowing the or any other user to link one or more of the areas to another area that has the same, or at least similar, user-defined parameters associated therewith which may build up a network of areas having the, or at least similar, parameters; and
iii) allowing the or each user to access the network of areas to obtain information about any one or more of the areas and/or of the network.

Such embodiments, provide a new way of structuring data that enables a user to locate that data more readily. Being able to locate data more readily will typically reduce the amount of network resource that is needed since it is being used more efficiently.

Typically a user-defined area may relate how spaces of interest around us are interconnected; what makes people move and come together around the world? For example, a user-defined area may relate to any of the following, or the like:
Entertainment: Music, sports, tours, tournaments, contests, golf course tees, Olympics, F1, Tour de France, etc.
Travel: links, hubs, routes, itineraries, trips, tourism, etc.
Urban structures: districts, regions, industrial zones, counties, town twinning, etc.
Places to visit: tourist attractions, tallest buildings, wonders of the world, oldest trees, etc.
Places of congregation: conference venues, parks, squares, greens, churches, exam halls, registry offices, etc.
Historical or new events: D-day landings, Arab spring demonstrations, disease outbreaks, disaster, etc.
Social events: celebrations, flash mobs, evenings out.

Embodiments providing such a method can facilitate information retrieval.

The above examples of areas relative to a map may be referred to as Geopspatial data. Typically geospatial data is highly persistent and changes more slowly with time when compared to other social data.

Other aspects of the invention provide computer systems to provide the above method and computer readable media carrying instructions which when read by a computing device cause that computing device to provide at least part of the method.

In a further aspect of the invention there is provided a data structure including at least one of the following:
i) a geographically specified area;
ii) a user-defined parameter; and
iii) data; and
wherein the data structure may be arranged such that a user can obtain the data by searching the data structure for the geographically specified area and/or the user-defined parameter.

According to one aspect of the invention there is provided a computer system including a machine readable medium which contains instructions which when processed by the computer system cause the computer system to:
transmit data representing a map to a remote computing device for display to a user thereof;
receive area-data defining a user defined area, relative to the map, wherein the area has associated therewith one or more user-defined parameters that hold for that area;
cause the computer system to process the area-data and to link areas having the same, or at least similar, user-defined parameter associated therewith thereby building up a network of areas having the same, or at least similar, parameters; and
allowing the or each user to access the network of areas, by obtaining data from the computer system, to obtain information about any one or more of the areas and/or of the network.

Embodiments providing such a data structure may facilitate easier and quicker access to the data.

A mention of a computer readable medium may refer to any of the following non-exhaustive list:

a hard drive; a CD ROM/RAM; a DVD ROM/RAM (including -R/-RW; +R/+RW); any form of optical medium; a memory (including an SD card; USB memory drive; a Compact Flash card; a floppy disc; a transmitted signal (such as an Internet download; ftp file transfer or the like).

### BRIEF DESCRIPTION OF THE DRAWINGS

There now follows by way of example only a detailed description of embodiments of the present invention with reference to the accompanying drawings in which:

FIG. 1 shows an example network to provide an embodiment;

FIG. 2 shows an example map on which an area has been defined by a user;

FIG. 3 shows a first screen of a mobile computing device;

FIG. 4 shows an example of overlapping user-defined areas;

FIG. 5 exemplifies how a user expands a user-defined area;

FIG. 6 exemplifies a second screen of a mobile computing device;

FIG. 7a shows how user-defined areas may be linked to form a network thereof;

FIG. 7b shows a further example of how a user-defined area may be linked to form a network;

FIG. 8 exemplifies search results provided by an embodiment;

FIG. 9 exemplifies how, in a further embodiment, how data from geographical regions is aggregated;

FIG. 10 exemplifies how data from grouped geographical regions, as shown in FIG. 9, can be collated; and

FIG. 11 exemplifies how data from grouped grouped geographical regions can be collated.

### DETAILED DESCRIPTION OF THE INVENTION

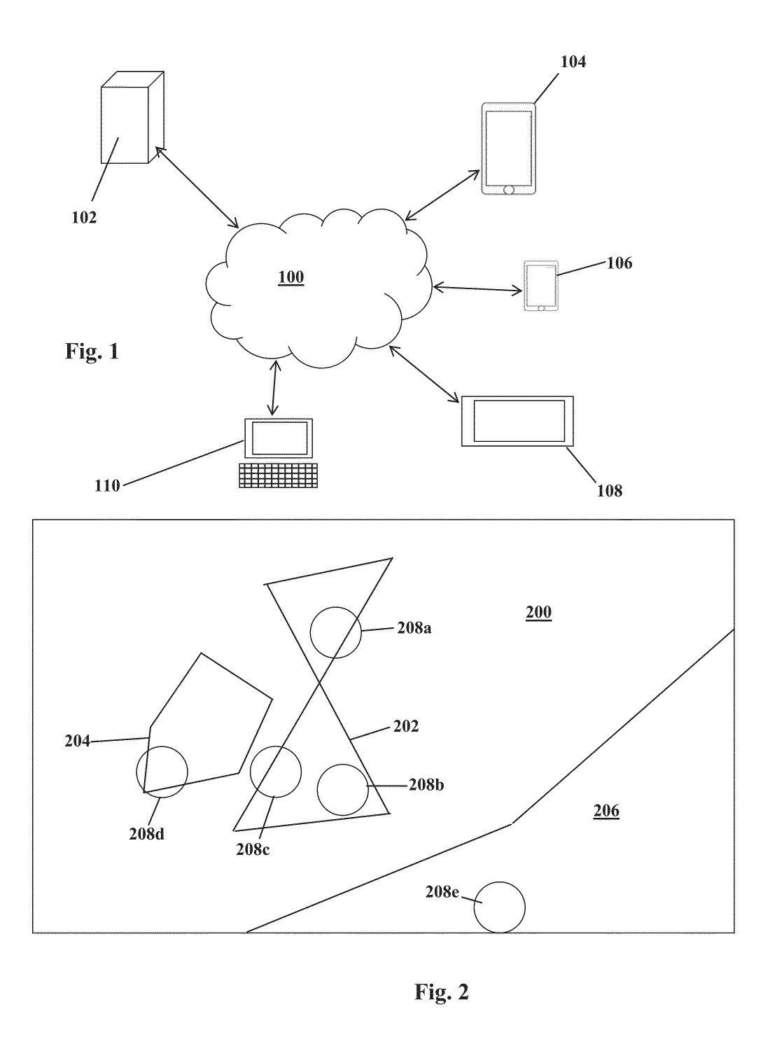

FIG. 1 shows a typical network arrangement used to provide embodiments. In the embodiment being described, the network 100 comprises the World Wide Web (WWW) running on top of the Internet. In other embodiments the network 100 may comprise any suitable network including any suitable wired or wireless infrastructure.

FIG. 1 further shows a server 102 connected to the network 100. Although shown as a single device within the Figure, the skilled person will appreciate that a server may in fact comprise a number of computing devices connected. Here, the or each server may be thought of as first computing devices which are arranged to receive data requests from, and to send data to, the network 100.

Also shown in FIG. 1 are a number of computing devices, in addition to the server 100, each of which is capable of connecting to the server, across the network 100, and exchanging data with the server 100. The computing devices that are shown in the Figure are examples of the types of device that might be used and the skilled person will appreciate the number and variety of such devices. In particular the Figure shows a tablet (such as an iPad™; Windows™ or Android™ Tablet; Kindle™) 104; a smart-phone (such as an iPhone™; an Android™ or Windows™ 'phone; or a Blackberry™) 106; a smart TV 108; and a desk-top computer such as a PC or a Mac™ 110. There may be many other such devices.

Typically several servers 102 are provided and arranged to provide the system outlined below. A user of anyone of the computing devices 104-110 may access one of the servers 102 providing the embodiment and have the functionality described below provided to him or her.

The embodiment being described allows a user to access information, using a computing devices as exemplified in FIG. 1 to access and obtain information held elsewhere and accessible across the network 100, typically on the server 102. Here the computing devices 104-110 may be thought of as being remote computing devices in that they are remote from the server 102. In other embodiments, it is conceivable that a peer-to-peer embodiment may be provided and in such embodiments, one any device functioning as one of the peers may be thought of as being a first computing device arranged to receive data requests from, and to send data to, the network 100.

In particular, FIG. 2 shows a map 200 on which the British Isles 202; Eire 204; and parts of continental Europe 206 are schematically shown. On this map a user that has access to the system has defined a number of areas 208a-e. Each of the areas 208a is associated with a user-defined parameter and in the example given each area relates to a capital city of a Country: Edinburgh 208a; London 208b; Cardiff 208c; Dublin 208d; and Paris 208e. It will be noted that the area of the map covered by the areas 208a-e only loosely corresponds to the area of the Capital City. In the example given each of the areas 208a-e is shown as having the same diameter but this need not be the case as explained in later examples. Thus, the server 102 is arranged to send data representing the map and/or the user-defined areas associated with the map to the computing devices 104-110.

In other embodiments, a shape other than a circle may be used. However, a circle is convenient as it provides a simple way to provide a geographical indication relative to a map 200.

Some embodiments may refer to one of these areas associated with a user-defined parameter as a Trive™. Hereinafter, an area associated with a user-defined parameter is, for convenience, referred to as an “Area”.

### 1. The Purpose of an Area

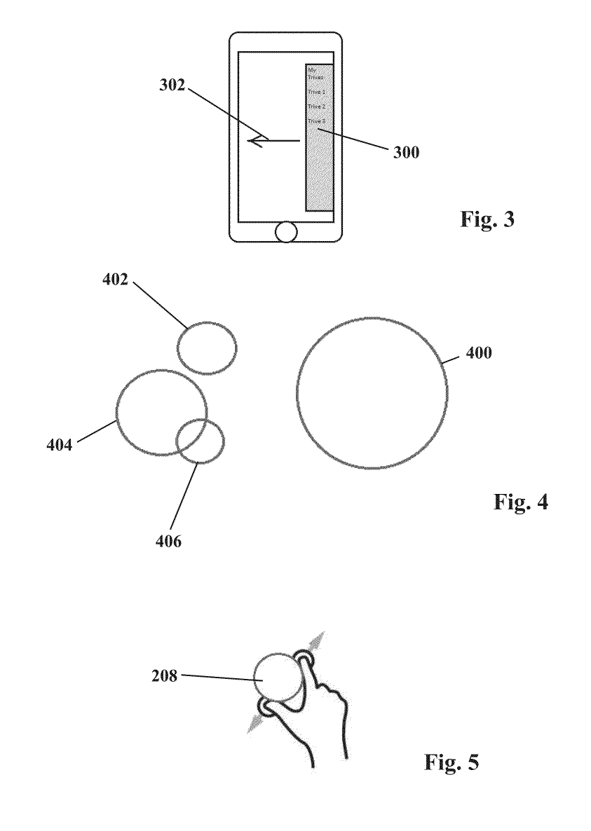

a. An Area (ie an area relative to a map) is a location of social interest. The purpose of An Area is to identify a geographic area, which may vary in size, and is of some particular interest to an individual user or a group of users. An Area allows an individual or a group to state the interest of the geographical area via the allocation of a name to The Area and to elaborate via a description for The Area (which will typically outline the user-defined parameter) and links to the network 100 (which in the embodiment being described is provided by the WWW).
   The Area may relate to any user-defined parameter and may for example provide historical information, networks of locations, social events, etc. The Area may be thought of as providing a Location of Social Interest (LSI) which is a geographical area which has some personal/emotional meaning to a person or groups of people.
   An Area is normally a member of a network of such Areas (some embodiments may refer to this network as a ‘Trive Network’) and therefore, each Area within such a network will share a ‘Network Relationship’ with other Areas that exist within the same Network.
      As a further example in addition to that given in FIG. 2:
         (1) An individual Area may be defined for the Underground Station “Canary Wharf Station” and such an Area will share a Network Relationship with the individual Area for the Underground Station “Canada Water Station” because both Areas belong to the Network of Areas ‘London Underground District Line’; Stations along the London Underground District Line.
         (2) If we were to diagrammatically illustrate the above example it would appear as:
         1. Network Name: “London Underground District Line”
         a. Area 1: “Canary Wharf Station”
         b. Area 2: “Canada Water Station”
   It will be appreciated that over time, Areas may be defined over which relate to the same user-defined parameter or otherwise deemed to be the same. However, it is conceivable and even likely, that such Areas may be labelled differently. As such, some embodiments, including the one being described, allow an Area to be marked as ‘equivalent’. Such embodiments may then allow a user to explore alternative definitions of the same user-defined parameter (ie LSI). Embodiments may be arranged to list equivalent Areas.
   Individuals and/or groups of people (ie Users) will have different, competing interests. These interests are likely to mean that Areas are created from users with differing perspectives. Embodiments may be arranged such that Areas (ie those created from differing perspectives) will gain their own level of popularity, perhaps using the ranking as described elsewhere.
   Embodiments may allow a user to their own version of an Area, with its own content, and use an Equivalence function to ‘compete’ with Areas created by other users which provide the same, or at least a similar, function; ie have an equivalence.
b. The individual (ie user) who created the Area (ie the creator) will have the opportunity to share the geographic interest with other users by making the Area public or private. Furthermore, the creator will have a record of Areas that they have created on his/her account with the system. Typically such a record of Areas may be listed via the computing device that that user is using. FIG. 3 shows an example of such a list shown on the Smartphone 106 as a “My Trives” list window 300. In the embodiment being described, the list window 300 is arranged such that a user may swipe 302 the window into view. The skilled person will appreciate the variety of other user interface techniques (buttons, list boxes, menus, button taps, voice commands and the like) that might otherwise be used to bring the list window 300 into view.
c. The individual who created the Area may have the opportunity to share the area of interest with others via an already existing social networking application such as Facebook™, Twitter™, or the like.
d. The individual who created the Area may have the opportunity to add content from other websites such as Wikipedia™, Picasa™ or the like. In such embodiments, the content may be added via a link to the content on another website.
e. An Area may have a ‘Rating’. Such a rating may be a composite score derived from any of the following factors: view count, modification count, followers, likes, etc. Embodiments may be arranged such that Areas that have a higher ranking are easier to find thereby ensuring that they become more prominent.
f. An Area may have an exact geographical radius as another Area (as in the example of FIG. 2). In such an instance, the Area may have one or more ‘tabs’ that reflect the content created for a user. For instance, the Area covering the geographical radius of ‘Canary Wharf’ may also cover the geographic location of ‘Fruit Lines Ltd’ and a user may be able to select either one by using a tab associated therewith. The skilled person will appreciate that here reference to tab is intended to mean a selection mechanism which may be a graphical tab part of a GUI, it may be a menu list, it may be a voice command input to the computing device, or the like.
g. Each Area will contain a set of attributes (Name, Description, Network Memberships, Followers/Likes, Quantity of Links, etc.) stored within a database via a unique attribute, which in the embodiment being described, is the circle radius and geographic coordinates. This will allow a database (or other structured mechanism for holding data) holding information about the Areas, which will typically be provided on a server 102 accessible over the network 100, to build and share crowd sourced geographic information to other web services, applications or enterprise users.
h. Areas are initially owned by their creators. However, as Areas gain popularity, it is likely that they will also gain in value. As such, embodiments may allow the ownership of an Area to be changed. For example, a user may wish to buy and/or sell an Area in the same way that a businesses may want to sell to Internet domain names.
   Embodiments may provide an auction/market function, allowing users to bid or otherwise purchase Areas (and/or Networks of Areas).

### 2. The Illustration of an Area

a. As shown in FIG. 2, the Area is illustrated on a geographic map 200 via the use of a circle 208, which is typically re-sizeable, and is superimposed on top of geographical map 200. The individual or group that creates an Area (ie the creator) determines the size of the circle at the time of creation of that Area. Therefore, circle sizes may vary, or in some instances, overlap as illustrated in FIG. 4 by the various Areas 400, 402, 404, 406.
b. Embodiments provide a mechanism that allows information to be seen about each Area. For example, some embodiments may provide a detail screen, a detail pop-up box, an audio announcement or the like to provide details about the area. This information mechanism logs the user-defined attributes of the Area, and in the embodiment being described this is the following:
   (1) Parent network (if any)
   (2) Name
   (3) Description
   (4) Locked state (eg locked or unlocked)
   (5) Published state (eg private or public)
   (6) Creation date & user that created
   (7) Last modified date & user that last modified
   (8) Share Areas with a specific person via an already existing social networking application
   (9) Quantity of Followers
   (10) Quantity of Likes
   (11) Links from the Web
   Other embodiments may record other information (ie meta data) about the Area.

### 3. The Behaviour of an Area

a. The Area is illustrated on a geographic map eg 200 via the use of a circle 208. In the embodiment being described, the circle 208 is resizable by the creator as depicted in FIG. 5. In the embodiment being described, the re-sizing of the Area 208 is shown on a touch-screen where a user pinches the circle. Other devices, 104, 106, 108, 110 may use mechanisms appropriate to the user interface of the respective device. The computer 110 may for example use a pointer that is controlled by a mouse or other input device to the computer 110. However, the size of the circle correlates with the area of interest, for instance:
   (1) A circle that encompassed the entire geographic area of London within England would be indicative that the area of interest is London, England.
   (2) A circle that encompassed just the district of Canary Wharf within London would be indicative that the area of interest is Canary Wharf, London, England.
b. An Area can be resized to increase the area of geographic interest. An Area can also be repositioned to change the area of geographic interest.
c. An Area can be in a ‘locked’ or ‘unlocked’ state. Whilst locked, the user or the creator is unable to reposition or resize the Area.
d. An Area can be in a ‘Public’ or ‘Private’ state. Whilst in a Public state, it is possible for individuals and the creator to both modify and view the Area. Whilst in a Private state, it is only possible for the creator to both modify and view the Area. A private Area may be useful for example, for special interest groups and teams and allow them to exchange private and location-related information.

In the foregoing, reference to modification of an Area, refers to modification of any of the user-defined parameters, meta-data, and the like associated with that Area.

Embodiments, including the one being describe, allow an Area to be reused such that an Area only need to be defined once. After the Area has been defined it may be re-used by anyone that has access to that Area, perhaps across the network 100. As such, an Area may be thought of as being a ‘geographical anchor points’ for social internet content.

### 4. The Purpose of a Network of Areas

a. A Network of Areas is simply the linking of two or more Areas. The purpose of a Network of Areas is to link previously identified geographic areas into one larger geographical relationship. The individual or group may state the interest of the geographical relationship via the allocation of a Name of the Network of Areas and to elaborate via a Description for the Network of Areas.

In some embodiments, including the one being described, a Network of Areas may optionally involve a linear/progressive aspect. Such linear/progressive aspects bring in a temporal element to the network and as such a network may then represent a geographical route, e.g. concert venues visited in turn by a music celebrity in a particular year; chronological time sequence, e.g. when pyramids were built around the world; or the like. In such embodiments a user is allowed to optionally rank or otherwise assign dates to each Area within the Network of Areas Member in the context of the Network, i.e. the ordering of an Area can be different for each Network it is a member of where the order can provide a temporal significance.
For instance:
b. The linking of the Area ‘Canary Wharf Station’ and the Area ‘District Line Station’ would create a scenario for the creation of the Network of Areas ‘London Underground District Line’. Here, the Network of Areas has allowed an individual or a group to link two Areas of interest together, thereby creating a geographic relationship.
c. The individual can also imply relationships by joining a Network of Areas to an already existing Network of Areas.
   (1) For instance, the individual may link the ‘London Underground District Line’ Network as a child to the already existing ‘London Underground Network’; the District Line being one of several Lines that make up the London
d. The individual who created the Network of Areas may have the opportunity to share the Network of Areas with others by making the Network of Areas public or private. Furthermore, the creator will have a record of Network of Areas that they have created via the My Networks list window 600, as illustrated in FIG. 6. In the embodiment being described, the list window 600 is arranged such that a user may swipe 602 the window into view. The skilled person will appreciate the variety of other user interface techniques (buttons, list boxes, menus, audio announcements and the like) that might otherwise be used to bring the list window 600 into view.
e. The individual who created the Network of Areas may have the opportunity to share the Network with others via an already existing social networking application such as Facebook™, Twitter™, LinkedIn™, or the like.
f. The individual who created the Network of Areas may have the opportunity to add content from other websites such as Wikipedia™, Picasa™, or the like.
g. Some embodiments, including the one being described, may allow a Network of Areas to have a ‘Rating’. In the embodiment being described, the rating is a composite of view count, modification count, followers and likes. Other embodiments may use a different combination as well as any other such parameters.

### 5. The Illustration of a Network of Areas

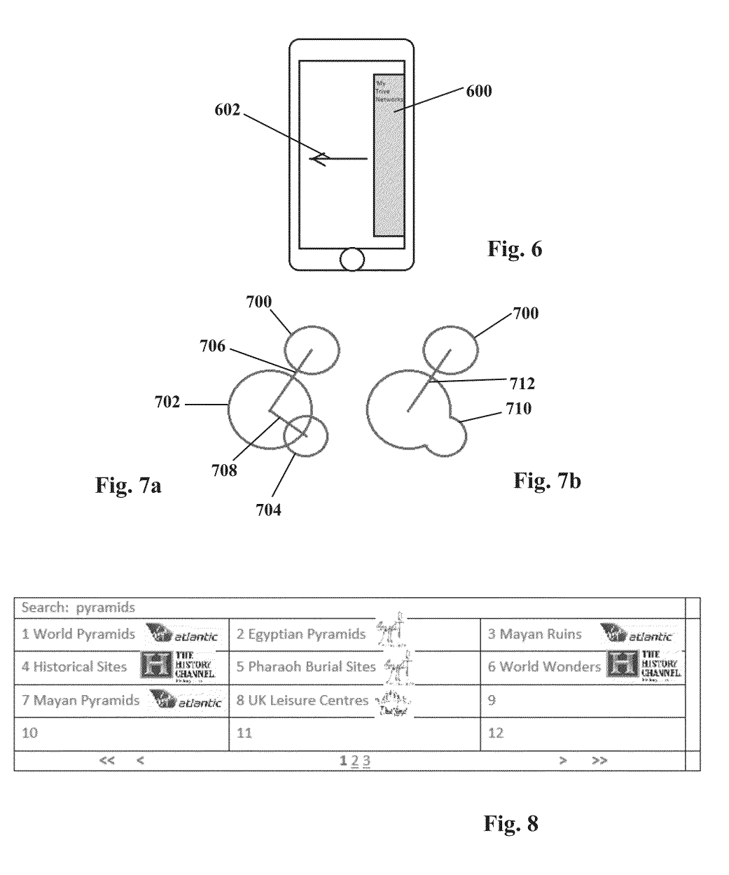

a. The Network of Areas is illustrated on a geographic map by connecting two Areas with a straight line (ie an area connector), as illustrated in FIG. 7. The line and circles are both superimposed on top of a geographical map (which has been omitted for reasons of clarity). The length of the line is determined by the geographic distance between the two Areas.
   In the example of FIG. 7a, the map has been omitted for reasons of clarity and the Areas and area connectors are all that is shown. In the Figure three Areas are shown 700, 702, and 704 are shown. The Areas 700 and 702 are connected by a network connector 706 and the Areas 702 and 704 are connected by the network connector 708.
   FIG. 7b shows an example in which the Areas of 702 and 704 of FIG. 7a have been merged together and therefore have a non-circular shape to form a compound area 710. The compound Area 710 is connected to the Area 700 by the network connector 712.
b. Embodiments provide a mechanism allows information to be seen about each Network of Areas. For example, some embodiments may provide a detail screen detail screen, a pop-up box, an audio announcement of the like to provide details about the Network of Areas. This information mechanisms logs the user-defined attributes of the Network of Areas, and in the embodiment being described this is the following:
   (1) Parent Networks (if any)
   (2) Child Networks (if any)
   (3) Network of Areas Member Names (eg
      3a Area Name A
      3b Area Name B . . . )
   (4) Network of Areas Name
   (5) Network of Areas Description
   (6) Locked state (eg locked or unlocked)
   (7) Published state (eg private or public)
   (8) Creation date & user that created
   (9) Last modified date & user that created
   (10) Share Network of Areas with a specific person via an already existing social networking application
   (11) Quantity of Likes
   (12) Links from the Web
Other embodiments may record other information (ie meta data) about the Network of Areas.

### 6. The Behaviour of a Network of Areas

a. The Network of Areas is illustrated on a geographic map via the use of two or more circles connected by one or more straight lines (as per FIG. 7a or 7b). Notably, a Network of Areas will connect three Areas with just two lines, as depicted in FIG. 7a.
b. Networks of Areas will likely significantly vary in size and the size of a Network of Areas is typically dependent on two factors:
   i. The quantity of peers within a Network of Areas: for instance the Network of Areas relating to ‘Welsh Skyscrapers’ may have just two members, whilst the Network of Areas relating to ‘English Skyscrapers’ may have four members.
   ii. The geographic distance between the Areas within a given Network of Areas: for instance a circle encompassing New York may be connected by a straight line to a circle encompassing London.
c. Embodiments may allow a Network of Areas to share a parent-child, or inversely, a child-parent relationship with one or more other Network of Areas, for example:
   i. A Network of Areas relating to ‘London’ may be the child of a parent Network of Areas called ‘Capital Cities’. Inversely, The Network of Areas relating to ‘London’ may also be the parent of a child Network of Areas called ‘London Underground Lines’.
   ii. If we were to illustrate the logical structure of the networks in example of the preceding paragraph, the three Networks of Areas would appear as: ‘Capital Cities’>‘London’>‘London Underground Lines’. Here, the grandparent Network of Areas is the ‘Capital Cities Network’ and the grandchild Network of Areas is the ‘London Underground Lines Network’.
Thus, some embodiments including the one being described allow a Network of Areas to be included as a member of another Network of Areas, which results in multi-level hierarchical structures, e.g. a university department can have various buildings, while a university can have various departments located across its campus. Some embodiments may conveniently refer to this as a Fractal Network™ where a related structure repeats at different levels of re-view.
In a similar that an Area can be a member of several Networks of Areas, a Network of Areas can be a member of multiple parent Network of areas.
Embodiments, including the one being described, thus allow users to build and explore Network structures and gain insights into how they are connected to each other. This is implemented by the ability to include Network of Areas as Members of other Networks of Areas, browse parent Networks of an Area, as well as the members of a Network of Areas.

Thus, it will be appreciated that a Network of Areas can be viewed as being conceptually the same as an Area. A Area (ie a user-defined area) may be thought of as being a Location of Social Interest (LSI). An Area may be thought of as being the smallest defined LSIs; the ‘leaf nodes’ of a hierarchical tree structure.

Thus, a Network of Areas may also be an area of interest.

An Area may be turned into a Network of Areas by adding another Area to it.

When a user, in use, views a Network of Areas on a map zooming out, thereby shrinking the map, may make it difficult to visualise individual Areas as their physical area becomes too small as shown on the map, the Areas start overlapping too much, etc. Should this happen, embodiments, including the one being described, are arranged to cluster Areas to represent them by a larger representative area.
d. Embodiments may allow a Network of Areas to be in a ‘locked’ or ‘unlocked’ state. Whilst locked, the user or the creator is unable to add or remove peers (ie further Areas) from the Network of Areas. Additionally, whilst locked, the user or the creator is unable to add the network as a child of another Network of Areas, similarly the Network of Areas cannot become a parent of another Network of Areas whilst in a locked state.
e. Embodiments may allow a Network of Areas to be in a ‘Public’ or ‘Private’ state. Whilst in a Public state, it is possible for individuals and the creator to both modify and view the Network of Areas. Whilst in a Private state, it is only possible for the creator to both modify and view the Network of Areas.

### 7. The Search Matrix

a. The Search Matrix is a tool provided for users of embodiments described herein to identify geographic areas of interest, that is Areas. A user enters a search term into the matrix and a search is then performed against recorded Names assigned to individual Areas, Network Names (ie names assigned to individual Networks of Areas), Descriptions and the like. In the embodiment being described the results populate the matrix as shown in FIG. 8. Other embodiments may provide any other format of search results.
   The Search Matrix provides organisations with an avenue to market their goods and services by displaying a relevant sponsor logo next to the search result as depicted in FIG. 8. Search results may be sponsored and clicking on a logo, or other similar link, takes the viewer to the sponsor's web pages.

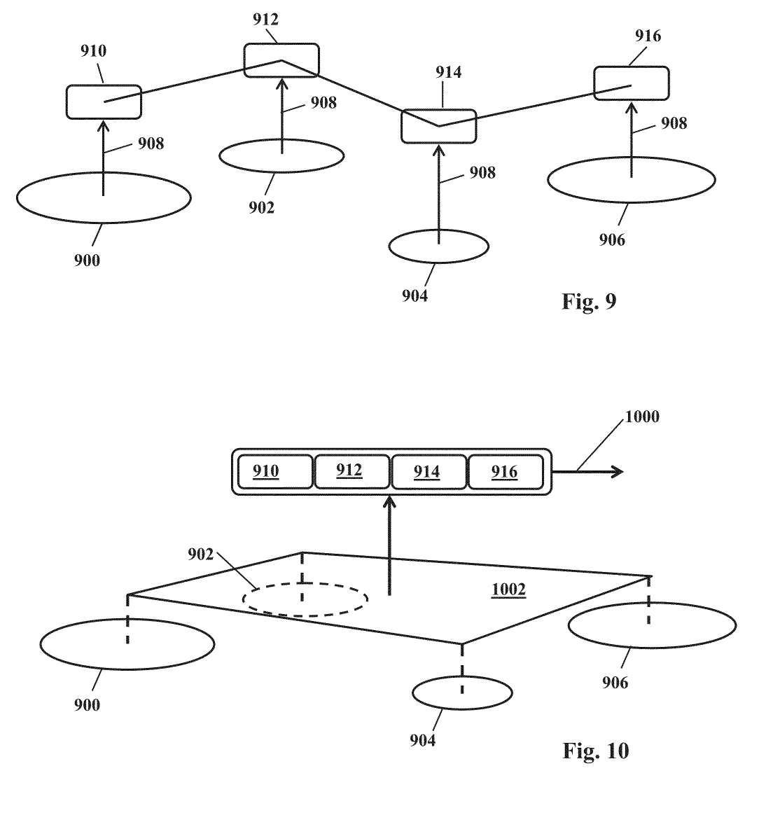

FIG. 9 exemplifies another embodiment in which a Network is formed to group data elements associated with different Areas to represent a larger relationship between those Areas. Thus, in FIG. 9, four Areas 900, 902, 904, 906 are shown.

A relationship exists between one of the Areas 900, 902, 904, 906 and a data element and this relationship is represented by the vertical arrow 908 Such data elements may be Tweets, Photos, other messages, or the like. Embodiments may then group those data elements together in a data-feed representative of the Network of Areas formed by the Areas 900, 902, 904, 906. In FIG. 9 the data elements that are being aggregated are represented by the rectangles 910, 912, 914, 916.

FIG. 10 shows the aggregate data feed 1000 that is formed for the Network of Areas 1002 formed from the Areas 900, 902, 904, 906. Some embodiments may be arranged to create the aggregate data feed 1000 automatically thereby automatically forming a network between Areas 900, 902, 904, 906 that did not previously exist. Such automatic aggregation may be based upon the content of the data elements 910, 912, 914, 916 may be based upon the content of the data elements. For example, and in one embodiment the automatic aggregation may be based upon a hashtag, or the like.

In other embodiments, which may be instead of or as well as the automatic aggregation, the aggregation of data elements 910, 912, 914, 916 may be according to the data-elements 910, 912, 914, 916 pre-existing relationship to an existing network of areas.

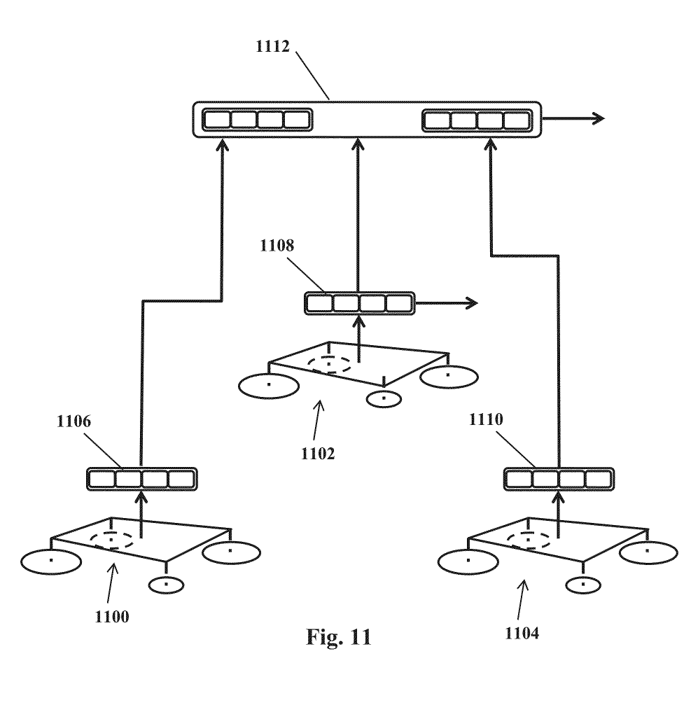

As is illustrated in FIG. 11, at least some embodiments will allow these aggregated data feeds to be themselves aggregated. FIG. 11 shows three networks of Areas 1100, 1102, 1104, each of which has an aggregated data feed 1106, 1108, 1110 that has been generated for that Area.

These aggregated feeds 1106, 1108, 1110 can then, selectively, be aggregated into a further feed. Embodiments of the system may allow users and/or administrators to define his/her own aggregation.

In the example of FIG. 11 it can be seen that an aggregated feed 1112 has been formed from the feed 1006 and the feed 1110. However, the feed 1108 has not been included into the aggregated feed 1112. Thus, it will be seen that at least some embodiments may filter the content of aggregated feed (whether from an Area, or a Network of Areas, or a Network of Networks) so that some content that would ordinarily be the subject of the aggregated feed is not present. The skilled person will appreciate that such filtering may be according to parameters such as content (such as keyword, hashtag, etc) matching, location matching, user black-lists, etc.

The skilled person will appreciate that any feature described above in relation to any aspect or embodiment of the invention may be used, mutatis mutandis, with any other aspect or embodiment of the invention.

What is claimed is:

1. A computerised method of allowing one or more users to access information, the method comprising:
causing a first computing device to transmit data representing a map to a remote computing device for display to a user thereof;
receiving at the first computing device area-data defining a user defined area, relative to the map, wherein the area has associated therewith one or more user-defined parameters that hold for that area;
causing the first computing device to process the area-data and to link areas having the same, or at least similar, user-defined parameter associated therewith thereby building up a network of areas having the same, or at least similar, parameters; and
allowing the or each user to access the network of areas, by obtaining data from the first computing device, to obtain information about any one or more of the areas and/or of the network.

2. A method according to claim 1 in which the first computing device is arranged to receive area-data that causes a hierarchical network of networks, to be generated, by linking the network of areas to further network of areas.

3. A method according to claim 1 in which the map is a geographic map.

4. A method according to claim 3 in which the area of the area defined, in the area-data, relative to the map does not have a geographical significance.

5. A method according to claim 1 wherein data defining the network of areas includes a temporal element indicating a sequence of events for areas within the network of areas.

6. A method according to claim 1 wherein the first computing device is arranged to receive query data defining a search to be performed against the user-defined parameters, is arranged to perform a search of the user-defined parameters as defined in the query data, and return the results of the search in result data to the user that generated the query data.

7. A method according to claim 6 wherein the first computing device is arranged to rank areas within the results returned in the result data according to a ranking which is stored for the or each area whereby the ranking affects how the area is reflected in the result data.

8. A method according to claim 1 in which data elements associated with any one of an area, a network of areas, a network of networks, are aggregated to form an aggregated data feed.

9. A method according to claim 1 in which data elements are processed to generate networks between areas, or existing networks, according to that processing.

10. A non-transient machine readable medium containing instructions which when read by a computer cause that computer to:
transmit data representing a map to a remote computing device for display to a user thereof;
receive area-data defining a user defined area, relative to the map, wherein the area has associated therewith one or more user-defined parameters that hold for that area;
cause the computer system to process the area-data and to link areas having the same, or at least similar, user-defined parameter associated therewith thereby building up a network of areas having the same, or at least similar, parameters; and
allowing the or each user to access the network of areas, by obtaining data from the computer system, to obtain information about any one or more of the areas and/or of the network.

11. A method of allowing one or more users to access information, the method comprising
receiving map-data, from a remote computing device, that represents a map together with and displaying that map to a user;
allowing user to define a user-defined area on the displayed map and to enter a user-defined parameter for the user-defined area, and generating area-data specifying the user-defined area and/or the user-defined area;
returning the area-data to the remote computing device.
